(19) United States
(12) Patent Application Publication
(10) Pub. No.: US 2026/0120664 A1
(43) Pub. Date: Apr. 30, 2026

(54) PIXEL CIRCUIT AND MICRO-DISPLAY APPARATUS COMPRISING SAME

(71) Applicant: RAONTECH, INC., Seongnam-si, Gyeonggi-do (KR)

(72) Inventors: Minsu JEONG, Seongnam-si, Gyeonggi-do (KR); Boeun KIM, Seongnam-si, Gyeonggi-do (KR)

(21) Appl. No.: 18/709,833

(22) PCT Filed: Nov. 4, 2022
(86) PCT No.: PCT/KR2022/017286

§ 371 Date: Feb. 6, 2025

(30) Foreign Application Priority Data
Nov. 19, 2021 (KR) 10-2021-0160401

(51) Int. Cl. G09G 3/36

(52) U.S. Cl. CPC G09G 3/3696; G09G 2300/0465; G09G 2330/021

(57) ABSTRACT

Disclosed are a pixel circuit and a micro-display device including the same according to an embodiment. The pixel circuit includes a first pixel circuit to which a voltage is applied from a driving circuit, a second pixel circuit to which a voltage is applied from the first pixel circuit, and a capacitor formed between the first pixel circuit and the second pixel circuit.

### CROSS-REFERENCE TO RELATED APPLICATIONS

This application is a U.S. National Phase Application under 35 U.S.C. § 371 of Patent Cooperation Treaty (PCT) Application No. PCT/KR2022/017286, filed Nov. 4, 2022, which claims the priority of Korean Patent Application No. 10-2021-0160401, filed on Nov. 19, 2021, the entire contents of all of which are hereby incorporated by reference herein, for all purposes.

### BACKGROUND

The present disclosure relates to pixel circuits and micro-display devices including the same.

In general, a display device is a device that displays an image on a display panel using electrical and optical characteristics, and includes liquid crystal displays (LCDs), organic light emitting diodes (OLEDs) displays, etc. The display device has a structure in which a plurality of pixels are arranged in the form of a two-dimensional matrix of rows and columns.

FIG. 1 is a view for explaining a pixel driving method of a conventional micro-display device.

Referring to FIG. 1, a display device generally uses a method of crossing column lines and row lines, storing desired data in a pixel circuit, and driving a pixel through the pixel circuit in order to implement C×R resolution. In order to implement the C×R resolution, the display device has to include C column driving lines and a driving circuit thereof, R row driving lines and a driving circuit thereof, and C×R pixel circuits.

In this case, in order to increase the resolution, values corresponding to C and R has to be raised to the desired resolution. That is, complexity of the driving lines and the driving circuit of the pixel are increased. Also, when a size of the driving pixel is constant, a size of the display device is increased as the resolution is increased.

### SUMMARY

Embodiments may provide pixel circuits and micro-display devices including the same.

A pixel circuit according to an embodiment includes a first pixel circuit to which a voltage is applied from a driving circuit; a second pixel circuit to which a voltage is applied from the first pixel circuit; and a capacitor formed between the first pixel circuit and the second pixel circuit.

The second pixel circuit may receive a voltage distributed by the capacitor from the first pixel circuit.

The distributed voltage may be determined by an average value according to a position of the second pixel circuit.

The first pixel circuit may be formed on a first layer of a panel, and the second pixel circuit may be formed on a second layer disposed above the first layer.

An electrode of the first pixel circuit and an electrode of the second pixel circuit may be connected by a via wire.

An electrode of the first pixel circuit and an electrode of the second pixel circuit may not be connected to each other.

An electrode of the first pixel circuit and an electrode of the second pixel circuit may be formed in different numbers.

An electrode of the first pixel circuit and an electrode of the second pixel circuit may be formed in different sizes.

The electrode of the first pixel circuit may be greater in size than that of the second pixel circuit.

The electrode of the first pixel circuit and the electrode of the second pixel circuit may at least partially overlap each other.

A micro-display device according to an embodiment includes the pixel circuit of any one of claims 1 to 10; and a pixel driving circuit which applies a voltage to the pixel circuit.

The micro-display device may further includes: a pixel compensation preprocessor which pre-processes an input image according to a driving of an average value of a capacitor coupling; and a resolution converter which converts a first resolution of the input image to a second resolution, and the pixel driving circuit may apply a voltage to the pixel circuit at the converted second resolution.

The second resolution may be set to be less than the first resolution.

According to the embodiment, the resolution may be improved by reducing the number of pixel driving circuits required to drive the pixel circuits by a certain ratio.

According to the embodiment, the number of pixel driving circuits may be reduced to improve power consumption.

According to the embodiment, since the area of the driving pixels may be minimized and the power consumption may be reduced the performance and power consumption of actual devices may be improved by reducing the power consumption and the area of substrates of micro-displays used in various driving types of pixel circuits including static random access memory (SRAM) circuits.

### BRIEF DESCRIPTION OF THE FIGURES

FIG. 1 is a view for explaining a pixel driving method of a conventional micro-display device.

FIG. 2 is a view illustrating a pixel circuit according to a first embodiment of the present invention.

FIGS. 3A and 3B are a plan view and a cross-sectional view, respectively, illustrating the pixel circuit illustrated in FIG. 2.

FIG. 4 is a view illustrating a modified pixel circuit according to the first embodiment of the present invention.

FIGS. 5A and 5B are a plan view and a cross-sectional view, respectively, illustrating the pixel circuit illustrated in FIG. 4.

FIGS. 6A to 6C are views illustrating an arrangement form of the pixel circuit according to the first embodiment.

FIG. 7 is a view illustrating a micro-display device to which the pixel circuit according to the first embodiment is applied.

FIG. 8 is a view illustrating a pixel circuit according to a second embodiment of the present invention.

FIG. 9 is a plan view illustrating the pixel circuit illustrated in FIG. 8.

FIG. 10 is a view illustrating a micro-display device to which the pixel circuit according to the second embodiment is applied.

FIGS. 11A and 11B are views illustrating an example of pixel resolution conversion according to an embodiment.

FIG. 12 is a view for explaining a driving process of a micro-display device according to an embodiment.

FIG. 13 is a view illustrating various arrangement structures of pixel circuit electrodes.

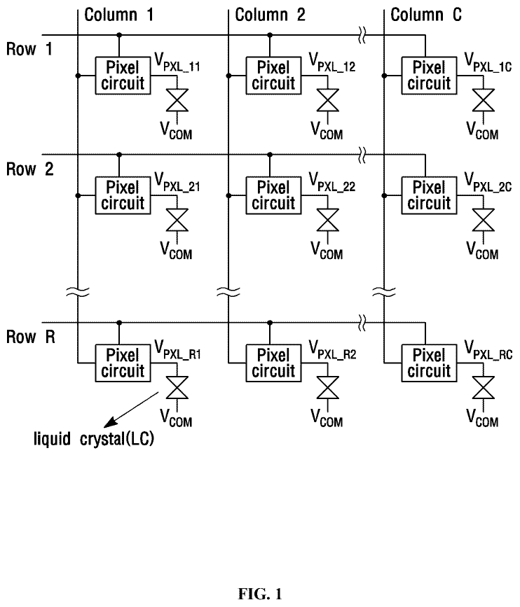

### DETAILED DESCRIPTION

Hereinafter, exemplary embodiments disclosed in the present disclosure will be described in detail with reference to the accompanying drawings and the same or similar components are denoted by the same reference numerals regardless of a sign of the drawing, and duplicated description thereof will be omitted. Suffix “unit” for components used in the following description is given or mixed in consideration of easy preparation of the present disclosure only and does not have their own distinguished meanings or roles.

Also, in describing the embodiment of the present disclosure, a detailed description of related known technologies will be omitted if it is determined that the detailed description makes the gist of the embodiment disclosed in the present disclosure unclear. Further, it is to be understood that the accompanying drawings are just used for easily understanding the exemplary embodiments disclosed in the present disclosure and a technical spirit disclosed in the present disclosure is not limited by the accompanying drawings and all changes, equivalents, or substitutes included in the spirit and the technical scope of the present disclosure are included.

Terms including an ordinary number, such as first and second, are used for describing various constituent elements, but the constituent elements are not limited by the terms. The terms are used only to discriminate one component from another component.

It should be understood that, when it is described that a component is “connected to” or “accesses” another component, the component may be directly connected to or access the other component or a third component may be present therebetween. In contrast, when it is described that a component is “directly connected to” or “directly accesses” another component, it is understood that no element is present between the element and another element. A singular form includes a plural form if there is no clearly opposite meaning in the context.

In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In an embodiment, a pixel circuit includes a first pixel circuit driven by a voltage applied from a pixel driving circuit and a second pixel circuit driven by a voltage distributed from the first pixel circuit. Here, the pixel circuit is referred to as a capacitor coupling pixel circuit.

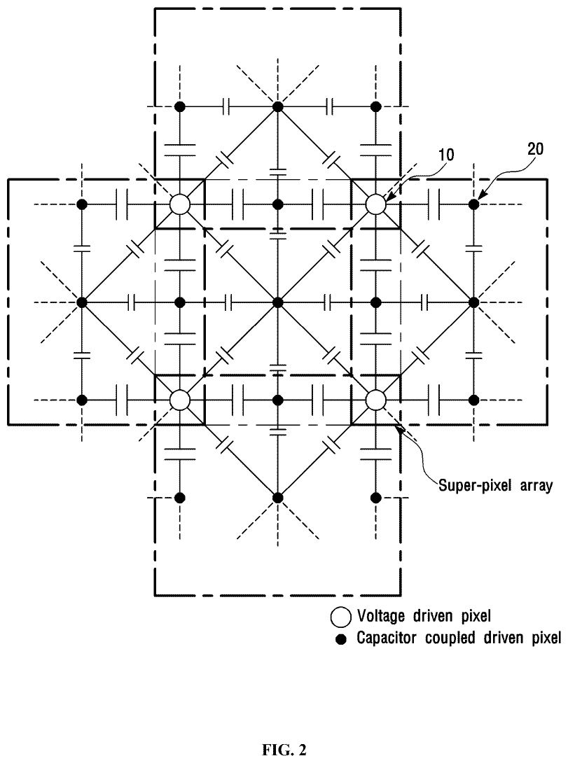

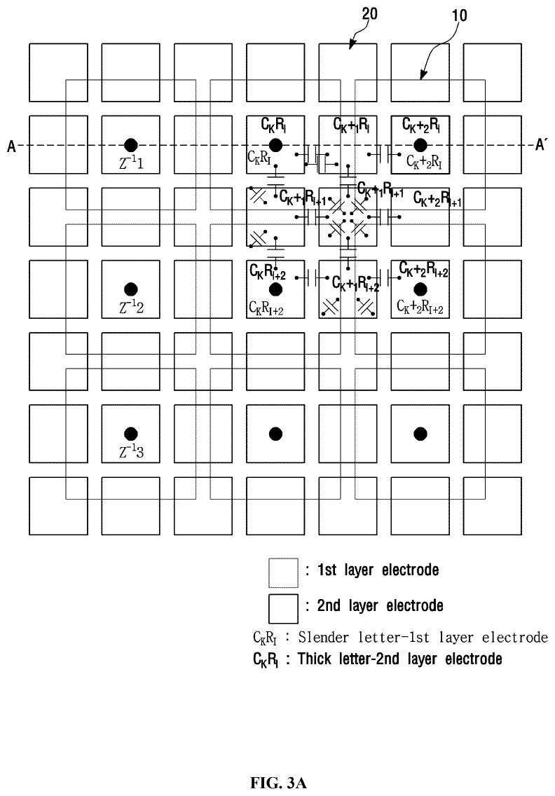

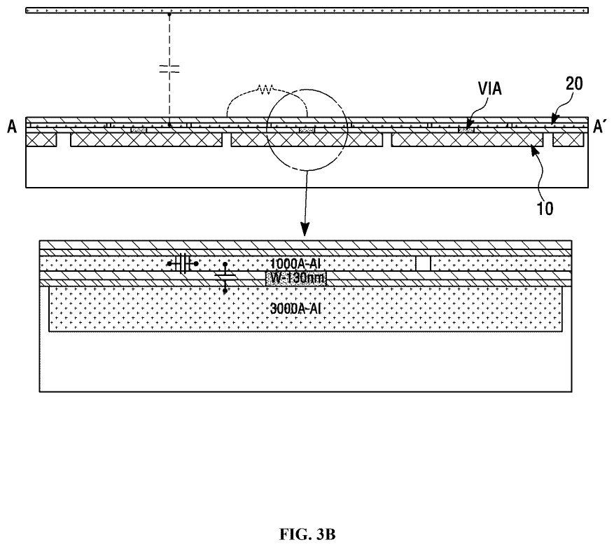

FIG. 2 is a view illustrating a pixel circuit according to a first embodiment of the present invention, and FIGS. 3A and 3B are a plan view and a cross-sectional view, respectively, illustrating the pixel circuit illustrated in FIG. 2.

Referring to FIG. 2, the pixel circuit according to the first embodiment of the present invention, which is a capacitor coupling pixel circuit, may include a first pixel circuit 10, a second pixel circuit 20, and a capacitor C.

The first pixel circuit 10 may be driven by a voltage applied from a pixel driving circuit including a column driving circuit and a row driving circuit.

The second pixel circuit 20 may be driven by a voltage distributed by capacitor coupling from the first pixel circuit 10 instead of directly receiving a voltage from the pixel driving circuit.

The capacitor C may be formed between the first pixel circuit 10 and the second pixel circuit 20. The capacitor C may be formed such that the second pixel circuit 20 and the first pixel circuit 10 are connected to each other. Also, the capacitor C may be formed such that the second pixel circuits 20 adjacent to each other are connected to each other.

In a pixel array of the first embodiment, the second pixel circuit driven by each average value by the capacitor coupling is disposed at a center of the first pixel circuit, and the number of pixels increases at a ratio of 1:4. Here, the ratio of 1:4 may represent a ratio between an electrode of the first pixel circuit and electrodes of the first pixel circuit and the second pixel circuit, and the ratio may be changed according to an arrangement or position of the pixel circuit.

For example, electrodes of CₖRₗ, Cₖ₊₂Rₗ, CₖRₗ₊₂, and Cₖ₊₂Rₖ₊₂ (Group1) of the first pixel circuit may be voltage-driven by a driving device. Electrodes of Cₖ₊₁Rₗ, CₖRₗ₊₁, Cₖ₊₁Rₗ₊₁, Cₖ₊₂Rₗ₊₁, and Cₖ₊₁Rₗ₊₂ (Group2) of the second pixel circuit may be connected by the capacitor through the electrodes of the first pixel circuit (Group1) instead of being directly connected to the driving device.

Depending on the arrangement of the electrodes, the electrodes of the first pixel circuit (Group1) and the electrodes of the second pixel circuit (Group2) may overlap each other by ½ or ¼ of the electrodes of the first pixel circuit and the electrodes of the second pixel circuit and overlap each other by electrode surfaces facing each other between the electrodes of the second pixel circuit.

The electrodes of the first pixel circuit and the second pixel circuit may be formed in different numbers, and at least a portion of the electrodes may overlap. The electrodes of the first pixel circuit and the second pixel circuit may be formed in different sizes, and the electrode of the first pixel circuit may be formed larger than the electrode of the second pixel circuit.

As illustrated in FIGS. 3A and 3B, the electrodes of the first pixel circuit (Group1) may be disposed on a first layer, and the electrodes of the second pixel circuit (Group2) may be disposed on a second layer.

In this case, an electrode of the first pixel circuit (Group1) and an electrode of the second pixel circuit (Group2) may be connected using a VIA wire. That is, the pixel circuit positioned at the center among the second pixel circuits disposed on the second layer is connected to the first pixel circuit disposed on the first layer using the VIA wire.

A dielectric material may exist between the layers, and a display element may be disposed between an upper end of the substrate and an upper end blue electrode.

A space between the electrodes may be filled with the dielectric material, a capacitor may be formed by the dielectric material, and a capacitance may be determined by an area in which the electrodes face each other.

The electrode of the second pixel circuit (Group2) is connected to the first pixel circuit (group1) or the second pixel circuit (Group2) only through the capacitor. However, in an actual circuit configuration, the electrodes are connected to each other at an extremely large resistance value due to an extremely low electrical conductivity of the dielectric material. This means that a parasitic resistance component does not affect voltage distribution at a frame rate at which the actual pixel operates. However, due to this parasitic resistance, the electrodes of the second pixel circuit (Group2) converge to the average value of the electrodes of the second pixel circuit (Group1) in a standby or operating state, thereby forming an initial voltage.

A voltage of the second pixel circuit (Group2) is determined by a capacitor voltage distribution formula according to the voltage change of the first pixel circuit (Group1) and the initial voltage of the second pixel circuit (Group2). In general, when values of the capacitors connected to respective electrodes are the same, the voltage of the second pixel circuit (Group2) has an average value of the connected electrodes.

In this case, the average value of the electrodes may be changed depending on a position of the pixel as follows.

As an example, when the electrode of the second pixel circuit completely overlaps the electrode of the first pixel circuit, the electrode of the second pixel circuit has a capacitance corresponding to an area of the electrode disposed in the first layer and the second layer. Here, since the electrode of the second pixel circuit does not overlap an electrode of other pixel circuits in the first layer, the electrode of the second pixel circuit is not connected to an electrode of the non-overlapping pixel circuits through the capacitor. That is, the electrode of the corresponding pixel circuit is affected only by the electrode of the second pixel circuit that overlaps the electrode of the first pixel circuit.

As another example, when the electrode of the second pixel circuit overlaps the electrode of the first pixel circuit by ½ left and right or up and down, the capacitance between the corresponding electrode of the second pixel circuit and the electrode of the first pixel circuit in the first layer overlapping the electrode of the second pixel circuit has the same value. In addition, the voltage of the second pixel circuit has an average voltage value of two overlapped electrodes of the first pixel circuit in the first layer according to the capacitor voltage distribution formula.

As another example, when the electrode of the second pixel circuit is disposed at a center of four electrodes of the first pixel circuit on the first layer, and overlaps by ¼ of each electrode of the first pixel circuit on the first layer, the capacitance between the corresponding electrode of the second pixel circuit and the overlapped electrodes of the first pixel circuit in the first layer has the same value. Also, the voltage of the second pixel circuit has an average voltage value of the four overlapped electrodes of the first pixel circuit in the first layer according to the capacitor voltage distribution formula.

According to the capacitor voltage distribution formula, when the voltage value of the electrode of the first pixel circuit (Group1) changes, the value of the electrode of the second pixel circuit (Group2) may be generally determined by an average value according to the position of the second pixel circuit (Group2). In an embodiment, through such configuration of the pixel circuit, an operation similar to that of a general digital resolution conversion device may be performed, and an image of each pixel may have an improved resolution in the form of an averaged image.

In addition, although the embodiment is described as an example including the first layer and the second layer, an intermediate layer may be further included. The intermediate layer may be disposed between the electrode layer disposed in the first layer and the electrode layer disposed in the second layer for various resolution conversions, and various types of capacitor networks may be formed to support various types of resolution conversions.

A stacked structure of the electrode layers including the first layer and the second layer according to the embodiment may create a capacitor network between the electrode layer in the first layer and the electrode layer in the second layer only by an arrangement of the electrodes and the dielectric material. That is, the resolution enhancement technology through the desired capacitor coupling may be implemented with an extremely simple structure without the need for an additional wire to connect the capacitor.

Also, capacitor formation may be induced by alternately arranging the electrode layer of the first layer and the electrode layer of the second layer so that at least a portion of the electrodes overlaps through a vertical arrangement of a semiconductor process.

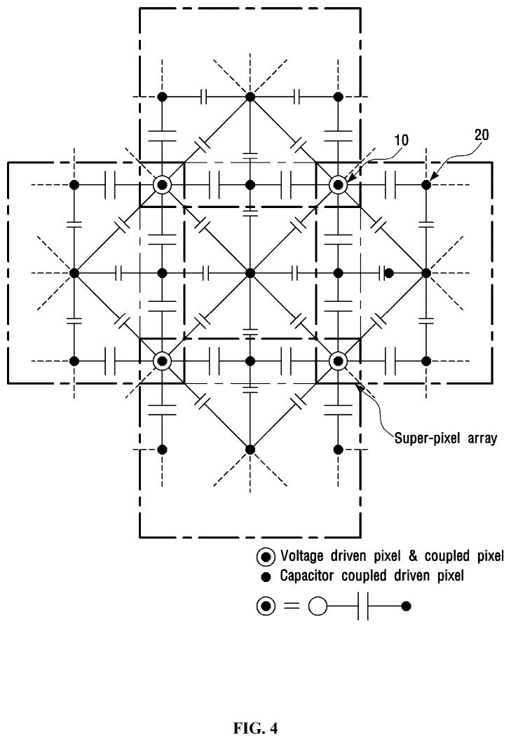

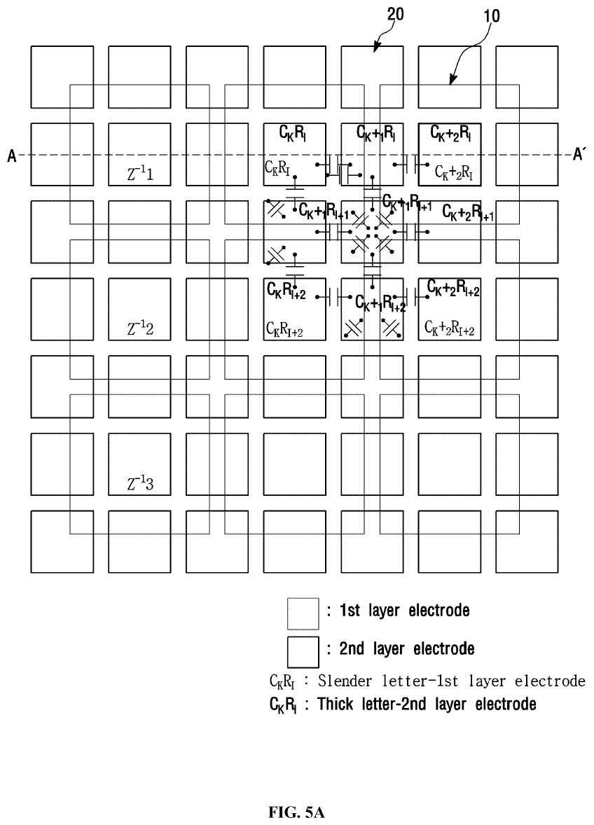

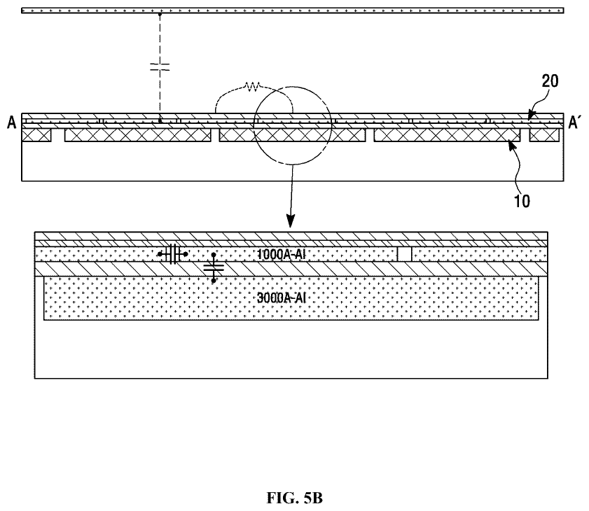

FIG. 4 is a view illustrating a modified pixel circuit according to the first embodiment of the present invention, and FIGS. 5A and 5B are a plan view and a cross-sectional view, respectively, illustrating the pixel circuit illustrated in FIG. 4.

Referring to FIG. 4, the modified pixel circuit of the first embodiment of the present invention, which is a capacitor coupling pixel circuit, may include a first pixel circuit 100, a second pixel circuit 200, and a capacitor C.

Since such a modified pixel circuit of the first embodiment has the same configuration, function or role as the pixel circuit according to the first embodiment of FIG. 2, a description thereof is omitted. However, the VIA wire of the first embodiment is not used, and only this will be described. When the first layer and the second layer are directly connected through a via because a thickness of the dielectric material is sufficiently small, an approximate voltage transfer may be performed. When there is the via, a process for forming the via should be additionally performed, and the flatness of the second layer may be affected by the via process, thereby deteriorating optical and physical properties of the second layer. That is, when there is a via layer, the voltage of the first layer may be transmitted to the second layer without loss. However, this may lead to process addition and performance degradation.

As illustrated in FIGS. 5A and 5B, the electrodes of the first pixel circuit (Group1) may be disposed in the first layer, and the electrodes of the second pixel circuit (Group2) may be disposed in the second layer.

In this case, the electrode of the first pixel circuit (Group1) and the electrode of the second pixel circuit (Group2) are not connected by using the VIA wire. That is, the pixel circuit disposed at the center among the second pixel circuits disposed on the second layer is not connected to the first pixel circuit disposed on the first layer by using the VIA wire.

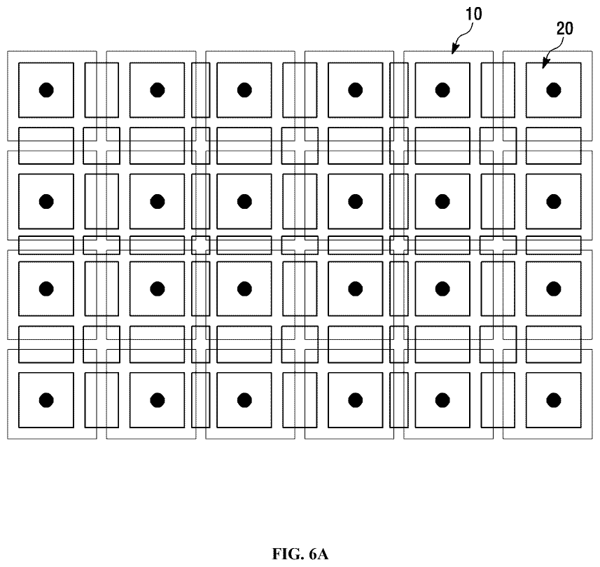

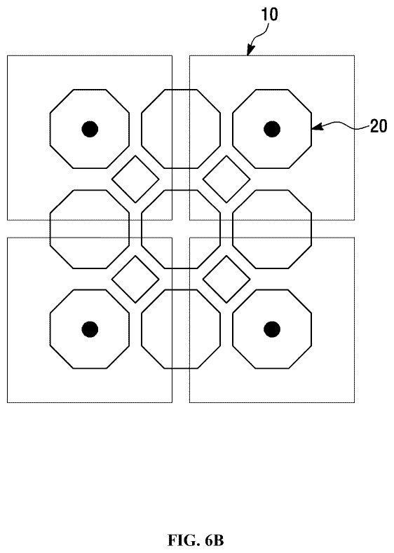

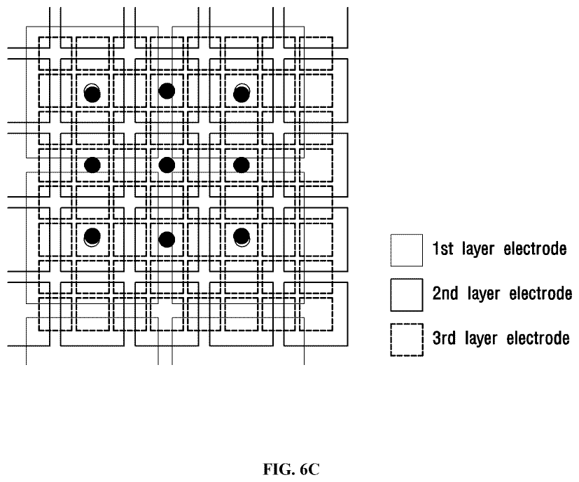

FIGS. 6A to 6C are views illustrating an arrangement form of the pixel circuit according to the first embodiment.

Referring to FIGS. 6A to 6C, various arrangement forms of the pixel circuit according to the first embodiment are shown, which may have various electrode shapes and may be arranged in a structure of three or more layers.

FIG. 6A illustrates a case in which electrodes of each pixel circuit are formed to have different sizes. FIG. 6B illustrates a case in which the electrode shape of the second pixel circuit is not rectangular. FIG. 6C uses a three-layer structure instead of a two-layer structure. This illustrates a case in which pixel resolution is amplified at a ratio between electrodes of 1:16 through a ratio between electrodes of 1:4 of a two-stage structure. However, this is only an embodiment, and the present invention is not necessarily limited to these embodiments.

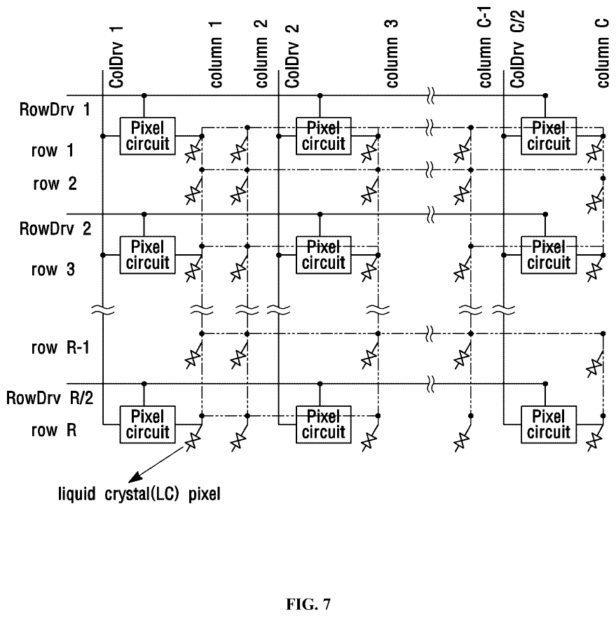

FIG. 7 is a view illustrating a micro-display device to which the pixel circuit according to the first embodiment is applied.

Referring to FIG. 7, the micro-display device to which the pixel circuit of the first embodiment is applied uses the capacitor coupling pixel circuit. Also, a resolution of C×R may be implemented by using (C/2) column driving circuits, (R/2) row driving circuits, and (C/2)×(R/2) pixel circuits.

As the electrode of the first pixel circuit and the electrodes of the first pixel circuit and the second pixel circuit are arranged at a ratio of 1:4, a voltage may be applied to one first pixel circuit to drive four second pixel circuits.

When the ratio between the electrode of the first pixel circuit and the electrodes of the first pixel circuit and the second pixel circuit is 1:4, the number of column driving circuits, row driving circuits, and pixel circuits may be determined by the electrode ratio, that is, a ratio of the electrode of the first pixel circuit and the electrodes of the first pixel circuit and the second pixel circuit.

Pixels meeting at odd columns and rows may be voltage-driven by the driving circuit. Also, for other pixels, a voltage may be determined by voltage distribution of the voltage-driven pixels.

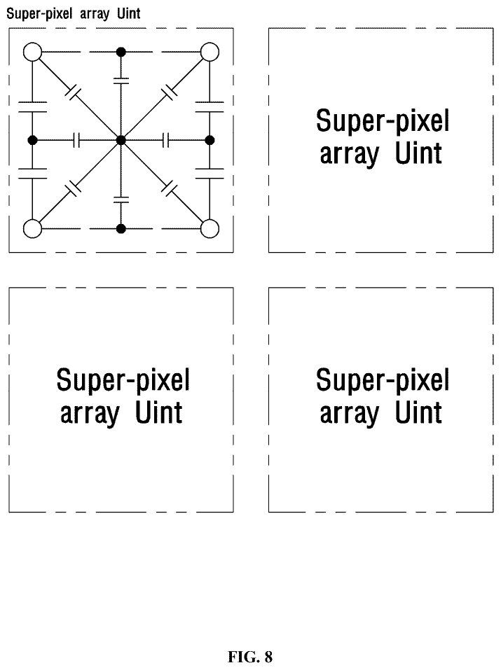

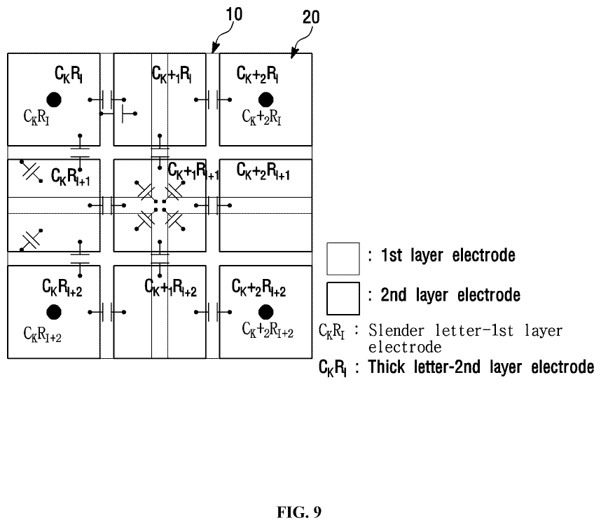

FIG. 8 is a view illustrating a pixel circuit according to a second embodiment of the present invention, and FIG. 9 is a plan view of the pixel circuit illustrated in FIG. 8.

Referring to FIGS. 8 and 9, the pixel circuit according to the second embodiment of the present invention, which is the capacitor coupling pixel circuit, may include a first pixel circuit 100, a second pixel circuit 200, and a capacitor C.

The pixel circuit according to the second embodiment has the same configuration and function as the pixel circuit according to the first embodiment of FIG. 2, and only the electrode arrangement form of the pixel circuit is different.

For example, the pixel circuit according to the second embodiment has a two-layer structure, and the electrode of the first pixel circuit and the electrodes of the first pixel circuit and the electrode of the second pixel circuit may be arranged at a ratio of 4:9.

Similarly, in the pixel circuit according to the second embodiment, the first pixel circuit and the second pixel circuit may be connected by using a via wire or may not be connected by using a via wire.

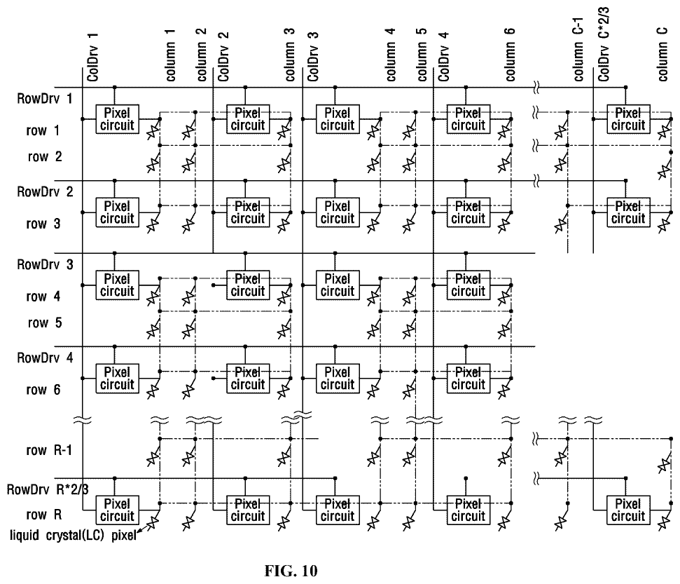

FIG. 10 is a view illustrating a micro-display device to which the pixel circuit according to the second embodiment is applied.

Referring to FIG. 10, the micro-display device to which the pixel circuit of the second embodiment is applied uses a capacitor coupling pixel circuit. Also, a resolution of C×R may be implemented by using (C/2) column driving circuits, (R/2) row driving circuits, and (C/2)×(R/2) pixel circuits.

As the electrode of the first pixel circuit and the electrodes of the first pixel circuit and the second pixel circuit are arranged at a ratio of 4:9, a voltage may be applied to four first pixel circuits to drive nine second pixel circuits.

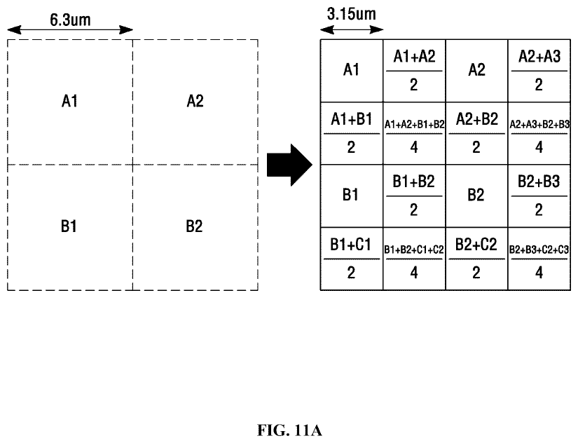

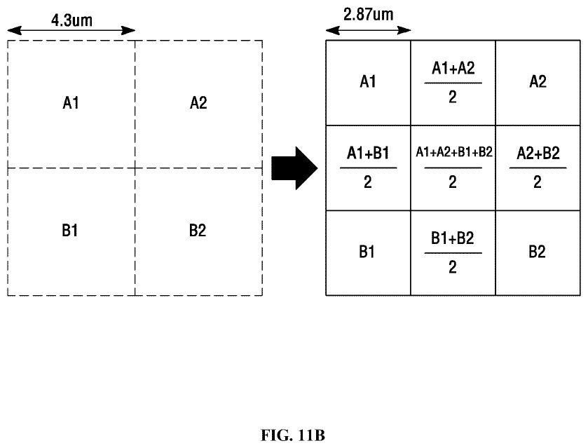

FIGS. 11A and 11B are views illustrating an example of pixel resolution conversion according to an embodiment.

Referring to FIG. 11A, an example of an increase in resolution is shown, and a pixel driving circuit designed to have an interval of 6.3 μm is connected to a pixel electrode having an interval of 3.15 μm, thereby implementing a quadruple increase in resolution.

Referring to FIG. 11B, an example of an increase in resolution is shown, and a pixel driving circuit designed to have an interval of 4.3 μm is connected to a pixel electrode having an interval of 2.82 μm, thereby implementing a quadruple increase in resolution.

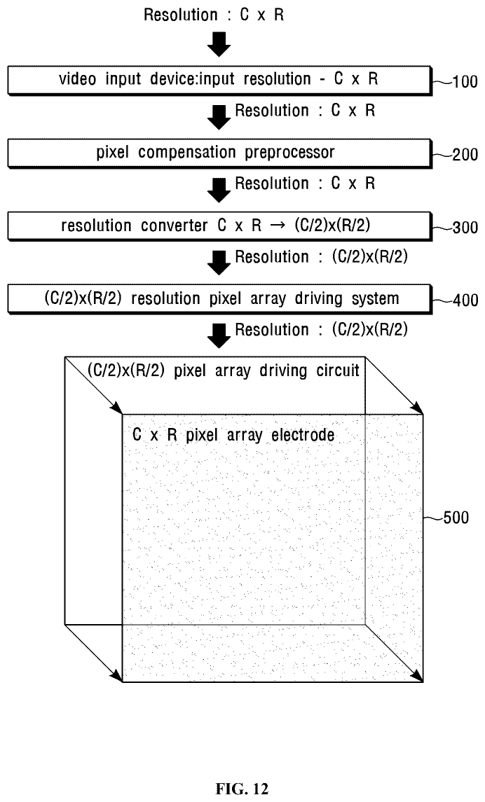

FIG. 12 is a view for explaining a driving process of a micro-display device according to an embodiment.

Referring to FIG. 12, a micro-display device 100 according to an embodiment may include an image input unit 100, a pixel compensation preprocessor 200, a resolution converter 300, a pixel driving circuit 400, and a pixel array 500.

The image input unit 100 may receive an input of a predetermined video or image to be displayed on a screen. For example, the input image may be an image having a resolution of C×R.

The pixel compensation preprocessor 100 may pre-process the input image by reflecting characteristics of the capacitor coupling in order to improve deterioration of image quality caused by driving of an average value of the capacitor coupling. To briefly explain the preprocessor, the proposed pixel enhancement technology mainly uses a method of improving resolution through average value insertion. That is, when an image of a corresponding inserted pixel of an original image is significantly different from the average value, a color of the pixel that determines the image to be inserted is preprocessed so that the image quality of the image is similar to the original image within a range allowed to be changed.

The resolution converter 300 may convert a resolution of C×R to a resolution of (C/2)×(R/2).

The pixel driving circuit 400 may drive the pixel array 500 with the resolution of (C/2)×(R/2). Here, the pixel array 500 may be a capacitor coupling pixel circuit including a voltage-driven first pixel circuit and a second pixel circuit driven through the capacitor coupling with the first pixel circuit.

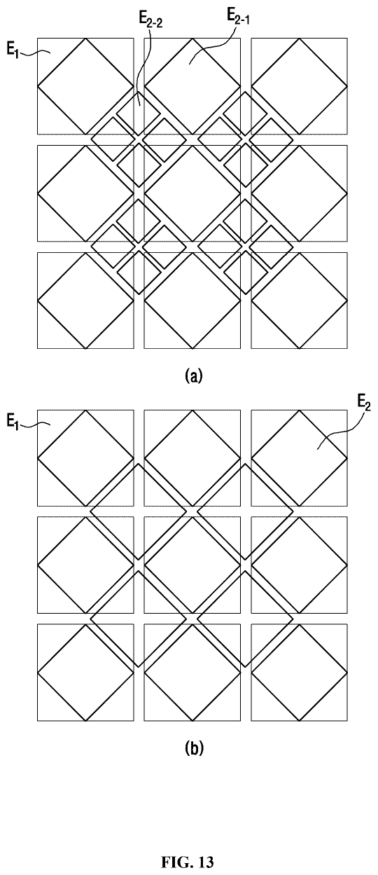

FIG. 13 is a view illustrating various arrangement structures of electrodes of first and second pixel circuits. As illustrated in FIG. 13, the electrode of the first pixel circuit may be disposed on a first layer, and the electrode of the second pixel circuit may be disposed on a second layer.

In this case, the electrode of the first pixel circuit may be implemented as a rectangle or square, and the electrode of the second pixel circuit may be implemented as a shape in which the electrode of the first pixel circuit is rotated by 45 degrees.

The electrodes of the first pixel circuit may be disposed on the first layer and arranged in a checkerboard shape. That is, the adjacent electrodes of the first pixel circuit may be spaced the same distance from each other.

The electrodes of the second pixel circuit may be disposed on the second layer and arranged in a checkerboard shape. That is, the adjacent electrodes of the second pixel circuit may be spaced the same distance from each other. In this case, the electrodes of the second pixel circuit may have only the same size or have different sizes.

First, as illustrated in (a) of FIG. 13, the electrodes of the second pixel circuit may include an electrode E₂₋₁ having a first size and an electrode E₂₋₂ having a second size. Specifically, in this case, the electrodes E₂₋₂ having the second size may form a 2×2 array and have the same size as the electrode E₂₋₁ having the first size. The electrodes E₂₋₂ having the second size and the electrodes E₂₋₁ having the first size in the 2×2 array may be alternately arranged in a left or right direction.

Next, as illustrated in (b) of FIG. 13, the electrodes of the second pixel circuit may include only electrodes E₂ having the same size and arranged in a checkerboard shape. In this case, some of the electrodes of the second pixel circuit may be disposed to completely overlap the electrode E₁ of the first pixel circuit of the first layer, and the rest of the electrodes of the second pixel circuit may be disposed in an area in which vertices of the four electrodes E₁ of the first pixel circuit of the first layer are gathered.

Although FIG. 13 illustrates various arrangements of various first and second layers, these are only examples, and the present invention is not necessarily limited to these examples.

The term ‘˜unit’ used in this embodiment means software or a hardware component such as FPGA or ASIC, and ‘˜unit’ performs certain roles. However, ‘˜unit’ is not limited to software or hardware. ‘˜unit’ may be configured to be in an addressable storage medium and may be configured to reproduce one or more processors. Therefore, as an example, ‘˜unit’ refers to components such as software components, object-oriented software components, class components, and task components, processes, functions, properties, and procedures, subroutines, segments of program code, drivers, firmware, microcode, circuitry, data, databases, data structures, tables, arrays, and variables. Functions provided within components and ‘˜units’ may be combined into smaller numbers of components and ‘˜units’ or further separated into additional components and ‘˜units’. In addition, components and ‘˜units’ may be implemented to play one or more CPUs in a device or a secure multimedia card.

Although the above has been described with reference to a preferred embodiment of the present invention, those skilled in the art will be understood that various modifications and variations can be made in the present invention without departing from the sprit and scope of the invention described in the claims to be described later.

### DESCRIPTION OF REFERENCE NUMERALS

10: First pixel circuit
20: Second pixel circuit
100: Image input unit
200: Pixel compensation preprocessor
300: Resolution converter
400: Pixel driving circuit
500: Pixel array

What is claimed is:

1. A pixel circuit comprising:
a first pixel circuit to which a voltage is applied from a driving circuit;
a second pixel circuit to which a voltage is applied from the first pixel circuit; and
a capacitor formed between the first pixel circuit and the second pixel circuit.

2. The pixel circuit of claim 1, wherein the second pixel circuit receives a voltage distributed by the capacitor from the first pixel circuit.

3. The pixel circuit of claim 1, wherein the distributed voltage is determined by an average value according to a position of the second pixel circuit.

4. The pixel circuit of claim 1, wherein the first pixel circuit is formed on a first layer of a panel, and the second pixel circuit is formed on a second layer disposed above the first layer.

5. The pixel circuit of claim 4, wherein an electrode of the first pixel circuit and an electrode of the second pixel circuit are connected by a via wire.

6. The pixel circuit of claim 4, wherein an electrode of the first pixel circuit and an electrode of the second pixel circuit are not connected to each other.

7. The pixel circuit of claim 4, wherein electrodes of the first pixel circuit and electrodes of the second pixel circuit are formed in different numbers.

8. The pixel circuit of claim 4, wherein an electrode of the first pixel circuit and an electrode of the second pixel circuit are formed in different sizes.

9. The pixel circuit of claim 8, wherein the electrode of the first pixel circuit is greater in size than that of the second pixel circuit.

10. The pixel circuit of claim 8, wherein the electrode of the first pixel circuit and the electrode of the second pixel circuit at least partially overlap each other.

11. A micro-display device comprising:
the pixel circuit of any one of claims 1 to 10; and
a pixel driving circuit configured to apply a voltage to the pixel circuit.

12. The micro-display device of claim 11, further comprising:
a pixel compensation preprocessor configured to pre-process an input image according to a driving of an average value of a capacitor coupling; and
a resolution converter configured to convert a first resolution of the input image to a second resolution;
wherein the pixel driving circuit applies a voltage to the pixel circuit at the converted second resolution.

13. The micro display device of claim 12, wherein the second resolution is less than the first resolution.
